(19) United States
(12) Patent Application Publication
(10) Pub. No.: US 2005/0102213 A1
(43) Pub. Date: May 12, 2005

(54) Systems and methods for accreting remarketable convertible securities

(76) Inventors: Serkan Savasoglu, New York, NY (US); Kevin G. Woodruff, New York, NY (US); Nathan McMurtray, New York, NY (US)

Correspondence Address: Michael D. Lazzara, Esq.;Kirkpatrick & Lockart, LLP, 535 Smithfield Steet, Pittsburgh,, PA, 15222-2312, US

(21) Appl. No.: 10/703,978

(22) Filed: Nov. 7, 2003

(51) Int. Cl. G06F 17/60

(52) U.S. Cl. 705/36

(57) ABSTRACT

A convertible security may include a maturity component, a conversion component, a contingent component, and a remarketing component. In general, the maturity component provides a maturity term of the convertible security. The conversion component provides terms and conditions for exchanging the convertible security for another asset. The contingent component provides one or more payment contingencies triggered upon the occurrence of one or more specified conditions. The remarketing component provides terms and conditions for remarketing the convertible security to new investors. After remarketing, the convertible security remains outstanding and potential recapture of excess tax benefits is postponed until the convertible security ceases to be outstanding.

### TECHNICAL FIELD

The present invention relates generally to investment instruments and, more particularly, to systems and methods for enhancing certain investment securities that incorporate contingent interest features.

### BACKGROUND

Firms traditionally issue conventional securities such as straight debt and common stock in order to raise capital. In general, straight debt securities (e.g., bonds, notes, loans, mortgages) enable firms to raise capital by borrowing and promising to repay a principal amount and interest on a specified future dates. Common stock securities, on the other hand, enable firms to raise capital by selling an equity interest in the firm. Owners of common stock typically receive voting rights regarding firm matters and may benefit through appreciation of the stock value and/or receiving dividends.

In addition to conventional types of securities, firms have a variety of more sophisticated hybrid investment instruments at their disposal. Hybrid securities may have attributes of several different types of securities (e.g., debt components and equity components) and may change optionally or automatically at certain points in time or depending on market conditions. Convertible securities, such as convertible debt, provide the issuer and/or the holder with the option of exchanging the convertible securities for other related securities, such as common stock. Convertible securities may be attractive to investors due to the mix of features, for example, earning interest like bonds when the stock price is down or flat and increasing in value like common stock when the stock price rises.

Mandatory convertible securities are another type of hybrid that, as the name implies, automatically convert into common stock on a specified future date. Mandatory convertible securities can have a variety of payoff structures that determine the number of shares of common stock provided to the holder. Typically, the number of shares depends on the market price of the stock on the conversion date relative to certain threshold prices and limits on appreciation.

In some cases, a convertible security includes a contingent interest feature that is triggered upon the occurrence of a specified condition. For example, the convertible security may provide contingent interest payments if the trading price of the bonds for each of the five trading days ending on the trading day prior to the first day of a period over which contingent interest may be payable is greater than or equal to 120% of the par amount for cash-pay bonds (i.e. bonds that pay interest) or 120% of the accreted value for zero-coupon (i.e. bonds that do not pay interest) or discount bonds (i.e. bonds that pay interest and have a principal amount that accretes). The first period for which contingent interest may be paid may be the six-month period starting on the first date the bonds become callable by the issuer. The contingent interest amount may be a fixed percentage of the average market price of the bonds on the five trading days prior to the first day of such six-month period.

For tax purposes, if the terms of a convertible provide for contingent interest payments, the issuer may take tax deductions based on the yield it would pay on a fixed-rate nonconvertible debt instrument with terms and conditions similar to those of the convertible security (“comparable yield”). The deductions are based on a schedule of projected payments with respect to the convertible debt (“projected payment schedule”). The projected payment schedule should produce a yield equal to the comparable yield. For accounting purposes, the issuer of the convertible security may need to establish deferred tax liability and deferred tax expense entries.

In every annual tax reporting period, for tax purposes, the issuer deducts a value equal to the tax adjusted issue price as of the beginning of the period multiplied by the comparable yield. The “tax adjusted issue price” as of the end of an annual period is the tax adjusted issue price as of the beginning of the period (or the issue price if the period is the first period), plus the tax adjusted issue price as of the beginning of the period multiplied by the comparable yield, minus any non-contingent and projected contingent cash payments to be made during the period. Deductions are adjusted upward or downward if the actual contingent interest paid is greater or less than that projected under the projected payment schedule. The tax adjusted issue price when the convertible ceases to be outstanding is compared to the value of securities and/or cash delivered value of securities and/or cash delivered to the holders to determine if the tax deductions are permanent.

By including a contingent interest feature that is neither remote nor incidental, issuers can claim tax deductions that differ from, and may exceed the stated yield on the convertible security. Excess deductions may be recaptured as income if the issuer does not ultimately deliver to the holders securities with a value equal to or greater than the tax adjusted issue price at the time the convertible security ceases to be outstanding.

The tax savings is permanent if the value of the securities and/or cash delivered to the holders is greater than the tax adjusted issue price. For example, this would be the case if the convertibles are converted into common stock with a value greater than the tax adjusted issue price at the time of conversion. If the value of the securities and/or cash delivered to the holders is less than the tax adjusted issue price, however, the issuer has taxable income equal to the difference between the tax adjusted issue price and the value of the securities and/or cash delivered to the holders. Also, if the convertible is eventually redeemed for cash and the value of cash delivered is equal to the accreted value, the excess tax deductions provide a timing benefit only (i.e., excess deductions are recaptured upon redemption).

Recapturing excess deductions, if any, may have financial implications for issuers and/or investors. In addition, there are unresolved issues as to the proper determination of the comparable yield. Therefore, systems and methods for enhancing investment securities to improve contingent interest features are needed.

### SUMMARY

In one general aspect a convertible security includes a maturity component, a conversion component, a contingent component, and a remarketing component. In general, the maturity component provides a maturity term of the convertible security. The conversion component provides terms and conditions for exchanging the convertible security for another asset. The contingent component provides one or more contingencies that are triggered upon the occurrence of one or more specified conditions. The remarketing component provides terms and conditions for remarketing the convertible security to new investors. After remarketing, the convertible security remains outstanding and potential recapture of excess tax benefits is postponed until the convertible ceases to be outstanding.

In another general aspect, a method may include issuing a convertible security to a holder and offering, at a remarketing time, the convertible security to one or more new investors.

In yet another aspect, a computer system may include an issuing agent (e.g. underwriter) and a remarketing agent. The issuing agent may issue a convertible security to a holder. The remarketing agent may offer, at a remarketing time, the convertible security to one or more new investors.

Aspects of the present invention may be implemented by a computer program stored on a computer readable medium. The computer readable medium may comprise a disk, a device, and/or a propagated signal. Other features and advantages will be apparent from the following description, including the drawings, and from the claims.

### DESCRIPTION OF THE FIGURES

FIG. 1 is a diagram illustrating an instrument according to one embodiment the present invention.

FIG. 2 is a flowchart illustrating a method according to one embodiment the present invention.

FIG. 3 is a diagram illustrating a system according to one embodiment of the present invention.

### DETAILED DESCRIPTION

The present invention is directed to structures, methods, and systems for remarketing convertible securities. For simplicity, the basic components of such structures, methods, and systems are provided. However, as would be understood by one of ordinary skill in the art, the structures, systems and methods described below may include various other components, elements, and/or processes in actual implementation.

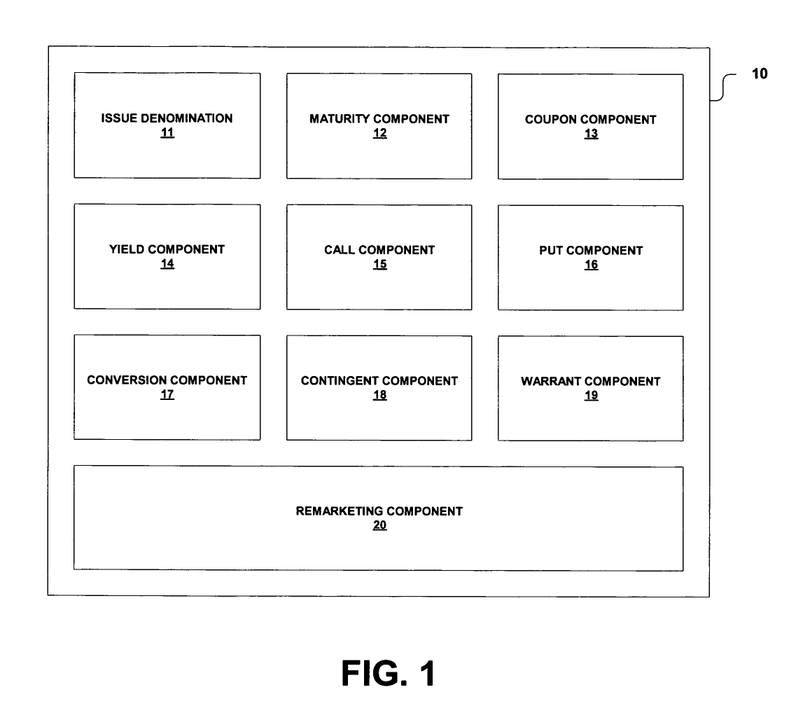

FIG. 1 illustrates one embodiment of a convertible security 10 according to aspects of the present invention. The convertible security 10 may be embodied as one or more paper and/or electronic documents and generally may contain one or more legal rights and obligations in the context of a financial transaction. In many cases, the convertible security 10 may form part of an offering by a company and may be listed on a national securities exchange.

One example of a convertible security 10 is convertible debt (e.g., convertible bond) that can be exchanged for stock (e.g., common stock) of the issuing company. The convertible debt may be a zero-coupon bond, a discount bond, or a cash-pay convertible bond with a coupon. The coupon may be a fixed rate or a floating rate (e.g., LIBOR minus 25 basis points). A convertible security may pay cash interest for a certain period (e.g., first five years) and then become a zero-coupon bond for the remainder of the term until maturity.

In one implementation, the convertible security 10 includes an issue denomination 11 (i.e. issue price) and a maturity component 12. In one embodiment, the issue denomination 11 is the face value (e.g., $1000 par value) of the convertible security 10. In general, the maturity component 12 indicates the term or life of the convertible security 10. The maturity component typically may express the term as a number of years (e.g., 30 years) from the issue date. In some cases, the maturity component 12 provides the date at which debt becomes due for payment.

As shown, the convertible security 10 also may include a coupon component 13 and/or a yield component 14. In general, the coupon component 13 may specify, at the time of issue, that interest payments are to be made at a particular rate and at a particular frequency (e.g., quarterly). If present, the coupon component 14 may express the particular interest rate as function of the London Interbank Offered Rate (LIBOR), or some other rate. The interest payment may also be a fixed rate. In some cases, the interest rate may be expressed as a percentage of the par value. In some embodiments, there may be no coupon component 13 and the convertible security 10 may be a zero-coupon security (e.g., zero-coupon bond).

In general, the yield component 14 may specify, at the time of issue, an annual rate of return. The rate of return may be based on the coupon rate, the maturity date, put and call dates and prices, and the issue price of the convertible security 10. If present, the yield component 14 typically is expressed as a percentage. The yield component 14 may be expressed as a function of LIBOR, some other variable rate or fixed rate. In some embodiments, there may be no yield component 14 and the convertible security 10 may be a zero-yield security (e.g., zero-coupon zero-yield bond).

The convertible security 10 includes a call component 15. In one embodiment, the call component 15 specifies, at the time of issue, certain conditions under which the issuer may call the convertible security 10 prior to maturity. In general, calling the convertible security 10 involves redeeming the convertible security 10 for a price. A company typically may call a bond, for example, when the interest rate it could achieve for a new issue of debt falls below the yield being paid on the bond or when the price of the bond rises to a certain point. The call component 15 may specify an initial time period in which the convertible security 10 cannot be called. For example, the call component 15 may specify, at the time of issue, that the convertible security 10 cannot be called for an initial five-year period.

The convertible security 10 also may include a put component 16. In one embodiment, the put component 16 specifies, at the time of issue, the terms and conditions (e.g., price, dates) under which the holder has the right to sell the security back to the issuer. In general, putting the convertible security 10 may involve the holder providing a put notice to the issuer and redeeming the bond for the par amount or the accreted value of the bond. The “accreted value” of the bond as of the end of an annual period is the accreted value as of the beginning of the period (or the issue price if the period is the first period), plus the accreted value as of the beginning of the period multiplied by the total yield, minus any non-contingent cash payments made during the period. A holder typically may put a bond, for example, when the stock price underlying the bond is low, interest rates are high, and the issuer's credit spread is high. The put component 16 may specify the dates when the convertible security 10 may be put to the issuer.

As shown, the convertible security 10 includes a conversion component 17. In one embodiment, the conversion component 17 specifies, at the time of issue, the terms and conditions for exchanging the security 10 for another asset, such as common stock of the issuer. The conversion component 17 may include, for example, a number of shares of the issuer's common stock (e.g., 5 shares) into which the convertible security 10 can convert. The conversion component 17 may also include, for example, a conversion price that specifies the dollar amount (e.g., $200) at which the convertible security 10 can be converted into common stock of the issuer.

The conversion component 17 also may include a conversion premium (e.g., 120%) expressing the extent to which the conversion price exceeds the price of the stock at the time of issue. In some situations, a company may set the conversion premium sufficiently low such that investors are willing to pay par value for a convertible security 10 that has no coupon and no yield.

The convertible security 10 also includes a contingent component 18. In one embodiment, the contingent component 18 specifies, at the time of issue, one or more contingencies that are triggered upon the occurrence of specified conditions. In general, the contingent component 18 is structured and arranged to ensure that the convertible security 10 qualifies for treatment as a contingent payment debt instrument (CPDI) under the tax code.

In one implementation, the contingent component 18 specifies that contingent payments (e.g., contingent interest) will be made to the holder. In general, such contingent payments are not remote in terms of probability and not incidental in terms of amount as required by the tax code. The contingent payment amount may be a percentage (e.g., 0.25%) of the average market price of the convertible security 10 over a testing period (e.g., five trading days ending on the trading day prior to the first day of a six-month period). The contingent payment amount also may be a certain fixed amount depending on the timing of the payment (e.g., $1.00 per bond between years 5 and 6, $1.10 per bond between years 6 and 7, etc.) The contingent component 18 also may specify a testing frequency (e.g., every six months) for evaluating whether the contingency is triggered.

In one implementation, the contingent component 18 includes a contingency providing that if the bond trades above 180% of the accreted value over a testing period, the company makes a payment to the holder equal to 0.25% of the bond price over the testing period.

In another implementation, the contingent component 18 may include a contingency providing that contingent interest payments will be made if the trading price of the bond is greater than or equal to 120% of the par amount (for a cash-pay bond) or 120% of the accreted value (for zero-coupon or discount bonds) over a testing period. The contingent component 18 also may include a contingency providing that the coupon will be increased if the stock price trades below a certain percentage (e.g., 60%) of the conversion price, for example.

In some embodiments, the convertible security 10 may include a warrant component 19. In general, the warrant component is designed to make the instrument more attractive to the investors. The warrant component may enable the issuer to attract investors in situations in which the conversion price may be too high for market conditions. One example of a warrant provides investors with an option to buy an additional number of shares (e.g., 5 shares of common stock) above the conversion price. Another example of a warrant results in the number of shares the convertible is convertible into to change based on the stock price. For example, the number of shares may increase as the stock price increases above the conversion price. Another example of a warrant fixes a conversion rate at a certain time (e.g., year 5).

In one embodiment, the convertible security 10 includes a convertible component 17 that provides an option for conversion into stock and a contingent component 18 that provides for one or more contingent payments that are neither remote nor incidental as required by the tax code. As a result, the convertible security 10 (e.g., convertible debt instrument) qualifies as a CPDI subject to the noncontingent bond method described in the tax code. Although conversion alone does not make the convertible security 10 to qualify as a CPDI, the value received upon conversion nevertheless is a contingency.

In one implementation, application of the noncontingent bond method involves determining the comparable yield for the convertible security by reference to a fixed-rate nonconvertible debt instrument with terms and conditions similar to those of the convertible security. In addition, a projected payment schedule is determined by treating the stock received upon a conversion of the convertible security 10 as a contingent payment. The comparable yield and the projected payment schedule are used to determine the tax deduction amount for each accrual period.

The comparable yield for the convertible security 10 can be the yield at which a fixed-rate nonconvertible debt instrument with terms and conditions similar to those of the convertible security 10 would be issued. Such terms and conditions may relate to maturity, payment frequency, subordination level, and market conditions, for example. In all cases, the comparable yield must be reasonably determined by the issuer. In some situations, the comparable yield may be set to the applicable Federal rate (AFR).

The projected payment schedule for the convertible security 10 generally will include each noncontingent payment and a projected amount for each contingent payment. In some implementations, the amount of the projected payment may be the forward price or expected value of the contingent payments as of the issue date. Adjustments may be made to ensure that the projected payment schedule and the issue price of the instrument produce the comparable yield.

Application of the noncontingent bond method also involves determining the interest for an accrual period, such as a taxable year. In general, the amount of interest for an accrual period is the product of the comparable yield and the adjusted issue price of the convertible security at the beginning of the accrual period. Typically, the holder treats the interest as taxable income, and the issuer treats the interest as a deduction. Application of the noncontingent bond method also may involve adjusting the amount of income or deductions. In some situations, the actual contingent payments may differ from the projected contingent payments. Accordingly, appropriate adjustments must be made by the issuer and the holder to reflect the difference. When the actual amount of the contingent payments is greater than the projected amount, a positive adjustment is made. A net positive adjustment generally is treated as interest and is included in taxable income by the holder of the instrument. The net positive adjustment is deductible by the issuer in the taxable year in which the adjustment occurs. When the actual amount is less than the projected amount, however, a negative adjustment is made. A net negative adjustment generally reduces interest accruals on the debt instrument for the taxable year. However, there may be certain limitations if the net negative adjustment exceeds the interest for the taxable year.

Typically, the issue of recapture may arise when conventional convertible securities cease to be outstanding due to conversion, an issuer call, a holder's put or retirement. The term “recapture” generally refers to the issuer paying taxes on excess tax deductions when the value of securities and/or cash deliveredvalue of securities and/or cash delivered to the holders is less than the tax adjusted issue price when the convertible ceases to be outstanding. For example, a conventional convertible bond may be issued having a thirty-year final maturity, an issuer call option after five years, and a holder's put option every 5 years until the final maturity (e.g., at years 5, 10, 15, 20, and 25). It may often be the case that the convertible will be put, called or converted prior to the final maturity.

When the convertible security is put, called, converted or retired, the tax adjusted issue price is compared to the value of the securities and/or cash delivered to holders. If when the convertible security 10 is converted, called, put or otherwise retired, the value of securities and/or cash deliveredvalue of securities and/or cash delivered to the holders is less than the tax adjusted issue price, the issuer may pay tax on the difference between the tax adjusted issue price and the value of the securities and/or cash delivered. For example, if the stock underlying a zero-coupon zero-yield bond goes very low at year five, a company runs the risk of being required to pay back par (e.g., $1000) as well as to pay income tax at the company's corporate tax rate on any prior excess deductions.

In contrast to conventional convertible bonds, however, the convertible security 10 includes a remarketing component 20. In one embodiment, the remarketing component 20 specifies, at the time of issue, the terms and conditions for remarketing the convertible security 10 to new investors. The remarketing component 20 may include one or more remarketing dates. In some implementations, the remarketing dates may coincide with call and/or put dates.

In some embodiments, the convertible security may not have any put dates at which holders may put the convertible to the issuer. Instead of such put dates, the convertible security may include remarketing dates at which holders may receive the remarketing amount after a remarketing.

In some implementations, a company may contract with a remarketing agent (e.g., investment bank) to remarket the convertible security 10. The remarketing agent may receive a remarketing fee, for example, of one quarter of one percent of a minimum selling price. In some cases, the convertible security 10 may be remarketed at a premium with the remarketing fee paid to the remarketing agent out of the proceeds, or the security may be remarketed at face value with the remarketing fee paid directly to the remarketing agent by the issuer.

In order to optimize the remarketing at the outset, the convertible security 10 may include provisions regarding the structure of the remarketing feature. In one implementation, at remarketing, the coupon or yield of the security is changed to enable the remarketed security (e.g., debt security) to be sold for an amount equal to a minimum price. For example, the coupon or yield may be adjusted according to market conditions to ensure that that the debt trades at par. The rates may be effective for the remaining term of the remarketed security or may change in response to certain time or market conditions.

In one embodiment, the convertible security 10 is remarketed as a new straight debt security. The convertible security 10 may provide that, after remarketing, the security may not be payable in or convertible into stock of the issuer. The debt may be remarketed as zero-coupon debt or as cash-pay debt (i.e., debt that pays a coupon).

In another embodiment, the convertible security 10 is remarketed as a new convertible security (e.g., cash-pay convertible, zero-coupon convertible or discount convertible, each with or without warrants, or any other features typical for convertible securities). The convertible security 10 may provide that, after remarketing, the issuer may call the remarketed security in certain situations.

In some cases, the remarketed security may be senior or subordinated and may or may not include deferrable interest. By definition, subordinated debt is junior to senior debt of the issuer and a deferrable interest clause may allow the issuer to defer interest payments for any reason before a specified date. An issuer may use subordinated/deferrable notes in order to achieve a certain credit rating, for example.

When the convertible security 10 is successfully remarketed to a new investor, the issuer and/or the remarketing agent may distribute the proceeds to the original investor. From the perspective of an original investor, this is satisfactory because the intent of the investor was to redeem the convertible security 10 for par or the accreted value. If the stock price was down, interest rates were up, and the issuer's credit spread was high, for instance, the original investor may have wanted to sell the convertible security 10. From the perspective of a new investor, straight debt was purchased at favorable terms based on current market conditions.

From the perspective of the issuer, the convertible security 10 is remarketed and remains outstanding. As a result, recapture is not triggered. Namely, a company may benefit by deferring recapture, if any, until maturity. In addition, the comparable yield may be determined with reference to a long-term fixed-rate instrument.

In one implementation, the comparable yield is in accordance with the maturity component 12 of the convertible security 10. For example, if the maturity component 12 specifies a thirty-year term, the comparable yield will be determined with reference to a thirty-year fixed-rate instrument.

With respect to conventional convertible bonds, for example, the probability that a thirty-year bond will remain outstanding until maturity may be low. First, there is a good chance that the bond may be “put” at the first opportunity (e.g., year 5). And, there also is the chance that the bond may be called. Based on these practicalities, there is an issue as to whether the comparable yield for a conventional convertible bond should be based on a shorter term than the maturity of the convertible bond.

In one aspect, however, the convertible security 10 obviates this concern due to the remarketing. Namely, the convertible security 10 remains outstanding after the remarketing date. As a result, a company is in fact utilizing the full long-term maturity of the convertible security 10. If interest rates are upward sloping, using the prevailing long-term rate may be more advantageous than a short-term rate.

In some implementations, the convertible security 10 may be remarketed several times. For instance, a remarketing may take place every year or every five years after the convertible security 10 becomes callable. For some companies (e.g., companies with strong credit ratings), remarketing one-year debt may not be problematic. However, companies with weak credit ratings may not be able to issue one-year debt securities because, for example, the average maturity in the high yield market is much longer than one year. Nevertheless, depending on an issuer's credit rating, remarketing may be possible as a one-year debt security, a five-year debt security, or a 10-year debt security, for example.

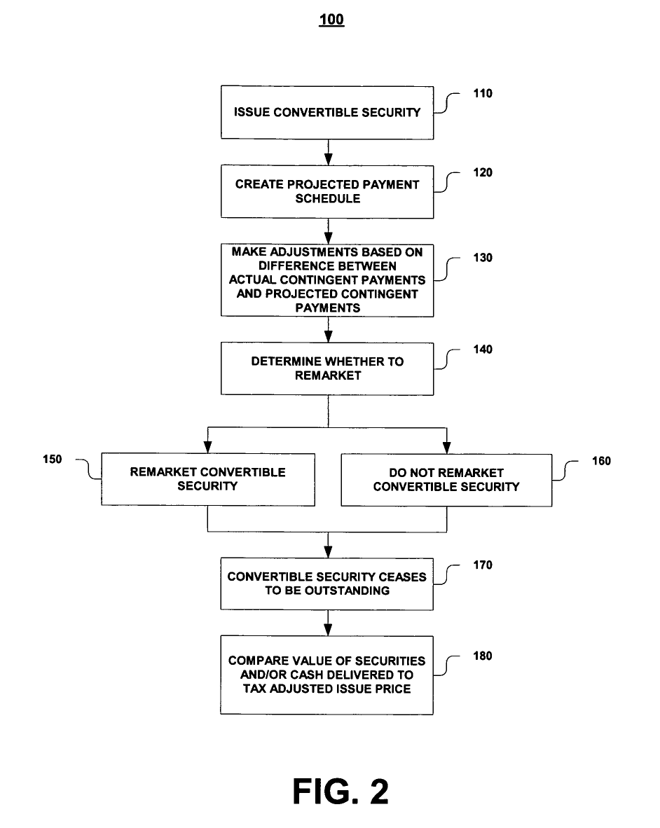

FIG. 2 illustrates a flowchart of one embodiment of a method 100 according to aspects of the present invention. In general, the method 100 may include issuing a convertible security (step 110), calculating projected contingent payments (step 120), making adjustments if the actual contingent payments differ from the projected contingent payments (step 130), determining whether or not the convertible security will be remarketed (step 140), remarketing the convertible security (step 150) or not remarketing the convertible security (step 160), time when the convertible security ceases to be outstanding (step 170), and calculating whether or not the issuer has taken excess tax deductions based on a comparison of the tax adjusted issue price and the value of securities and/or cash delivered to the holders (step 180).

At step 110, a convertible security is issued. The convertible security may be issued by a company and may be listed on a national securities exchange. One example of a convertible security is convertible debt such as a convertible bond (e.g., zero-coupon bond, discount bond, cash-pay bond). In general, the convertible security may qualify for treatment as a CPDI under the tax code if the security has a contingent interest feature.

In one implementation, the convertible security is a long-term (e.g., 30-year) convertible bond having a floating coupon (e.g., LIBOR minus 0.25%). The convertible bond may specify conversion terms (e.g., price, premium rate) for exchanging the bond for stock and contingent payment terms (e.g., triggering conditions, amount) for making contingent payments in certain situations. In general, the contingency is neither remote nor incidental as required by the tax code. The convertible security includes an initial call protection period (e.g., five years) and one or more remarketing dates (e.g., years 5, 10, 15, 20, and 25). The convertible security also may include a holder put option and one or more warrants.

At step 120, projected contingent payments are calculated. The calculations are performed at the time the convertible security is issued. In one implementation, the projected contingent payments are based on the forward price or the expected value of the contingent payments as of the issue date. The comparable yield can be determined by referencing the yield of a fixed-rate nonconvertible debt instrument with terms and conditions similar to those of the convertible. The projected payment schedule may include each noncontingent payment and a projected amount for each contingent payment.

At step 130, the actual contingent payments may differ from the projected contingent payments. Accordingly, appropriate adjustments must be made to reflect the difference. These adjustments must be made when a projected contingent payment differs from an actual contingent payment at any time on or after the issue date and on or before the time when the convertible ceases to be outstanding. When the actual amount of the contingent payments is greater than the projected amount, a positive adjustment is made. A net positive adjustment generally is treated as interest and is included in income by the holder of the instrument. The net positive adjustment is deductible by the issuer in the taxable year in which the adjustment occurs.

When the actual amount of the contingent payments is less than the projected amount, however, a negative adjustment is made. A net negative adjustment generally reduces interest accruals on the debt instrument for the taxable year. However, there may be certain limitations if the net negative adjustment exceeds the interest for the taxable year.

At step 140, the determination is made on whether or not the convertible security will be remarketed. The time at which this determination is made may be referred to as the “remarketing reset event date.” In one embodiment, whether or not the convertible security will be remarketed may be based on the stock price at or around the remarketing reset event date. For example, the convertible security may not be remarketed if the stock price at the remarketing reset event date is above the conversion price. For example, the convertible security may be remarketed if the stock price at the remarketing reset event date is below the conversion price. In another embodiment, whether or not the convertible security will be remarketed may be based on the convertible security's price at or around the remarketing reset event date.

At step 150, the convertible security is remarketed. The convertible security may be remarketed as a new straight debt security or as a new convertible security. For example, the convertible may be remarketed as a zero-coupon nonconvertible bond. The yield of the security may be set so that the security can be sold for a price equal to the accreted value of the convertible on the remarketing date. The convertible security may be remarketed annually (or periodically) thereafter for the accreted price. The convertible security also may be remarketed as a new convertible bond. This new convertible security may lack any remarketing dates until the maturity date, or at certain dates may be remarketed as straight debt or a new convertible bond based on a procedure similar to that described at steps 140 and 150.

In general, successful remarketing allows the issuer to leave the convertible security outstanding. In some cases, multiple remarketing may be performed so that the convertible security remains outstanding until maturity. As a result of remarketing, the potential recapture of excess tax benefits is postponed until maturity of the long-term convertible security.

At step 160, the convertible security is not remarketed. However, the next step may again be step 140, which may be another remarketing reset event date (e.g., years 10, 15, 20, 25) when the determination is made on whether or not the convertible security will be remarketed. After step 140, the next step may be step 150 if the convertible security will be remarketed, or the next step may be step 160 if the convertible security will not be remarketed. If the convertible security is not remarketed, the next step may again be step 140, which may be another remarketing reset event date (e.g., years 15, 20, 25) when the determination is made on whether or not the convertible security will be remarketed. This process may continue for a certain number of steps. However, after some future date (e.g., after year 25), step 160 may not revert back to step 140.

At step 170, the convertible may cease to be outstanding because the convertible is redeemed at maturity, converted at some date on or before maturity, called by the issuer or put by the holders.

At step 180, when the convertible security ceases to be outstanding, the tax adjusted issue price is compared to the value of the securities and/or cash delivered to the holders. If the value of securities and/or cash delivered to the holders is less than the tax adjusted issue price, the issuer may pay tax on the difference between the tax adjusted issue price and the value of the securities and/or cash delivered to the holders.

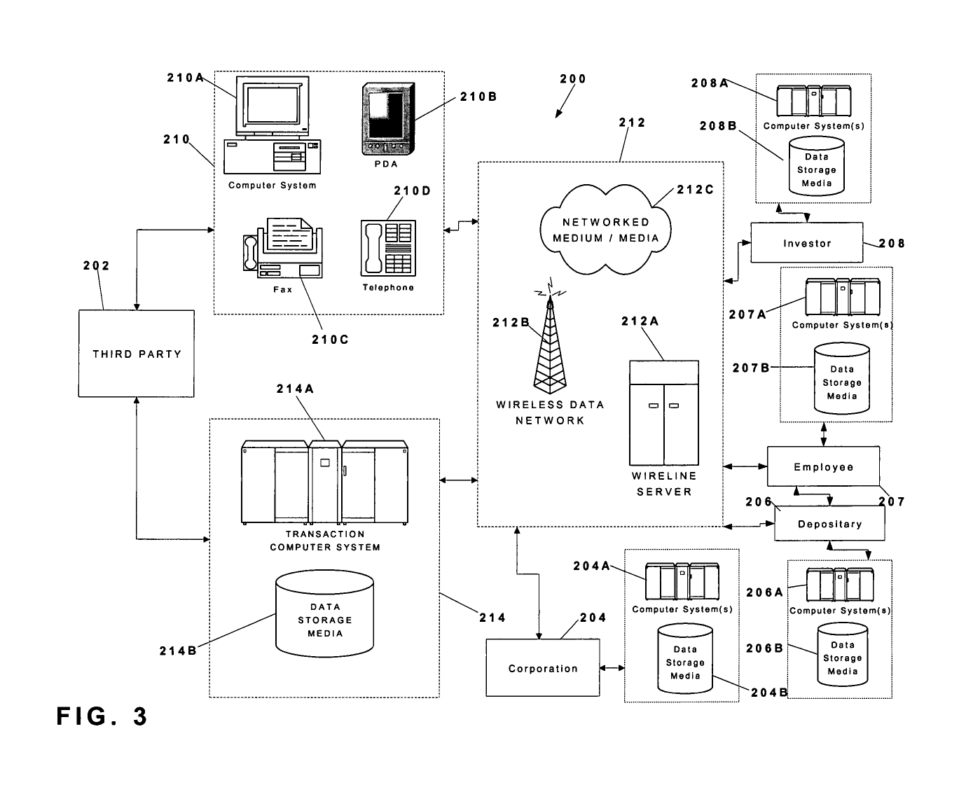

FIG. 3 is a diagram illustrating one embodiment of a system 200 in which aspects of the present invention may be used. As shown, a third party 202 such as, for example, an underwriter, an investment bank, or an entity can communicate and/or exchange data with one or more of a corporation 204, a depository 206 (e.g. The Depository Trust Company), an employee 207 and/or an investor 208.

In one implementation, the depository 206 may assign a unique identification such as a Committee Uniform Securities Identification Procedures (CUSIP) number, for example, to each security approved for trading. The CUSIP number may be used to track buy and sell orders for the units during issue and/or remarketing.

In one aspect, the third party 202 can be operatively associated with one or more communications devices 210 such as, for example and without limitation, a computer system 210A, a personal digital assistant 210B, a fax machine 210C, and/or a telephone 210D (e.g. a wireline telephone, a wireless telephone, a pager, and the like), and/or other like communication devices.

The communication devices 210 may permit the third party 202, the corporation 204, the depositary 206, the employee 207 and/or the investor 208 to communicate between/among each other through one or more communication media 212, such as by use of electronic mail communication through one or more computer systems, for example. The communication media 212 can include, for example and without limitation, wireline communication means such as a wireline server 212A, a wireless data network 212B, and/or a connection through a networked medium or media 212C (e.g., the Internet). In addition, the third party 202 (as well as any one or more of the corporation 204, the depositary 206, the employee 207 and/or the investor 208) can be operatively associated with one or more data processing/storage devices 214.

As illustrated in FIG. 3, the third party 202 can be operatively associated with a transaction computer system 214A, for example, and/or one or more data storage media 214B that can receive, store, analyze and/or otherwise process data and other information in association with communications that occur between/among the third party 202, the corporation 204, the depositary 206, the employee 207 and/or the investor 208.

In another aspect, the corporation 204 can be operatively associated with one or more computer systems 204A and/or one or more data storage media 204B. In another aspect, the depositary 206 can be operatively associated with one or more computer systems 206A and/or one or more data storage media 206B. In another aspect, the employee 207 can be operatively associated with one or more computer systems 207A and/or one or more data storage media 207B.

In another aspect, the investor 208 can be operatively associated with one or more computer systems 208A and/or one or more data storage media 208B. It can be appreciated that one or more of the computer systems (e.g., 204A, 206A, 207A, 208A, 214A) and one or more of the data storage media (e.g., 204B, 206B, 207B, 208B, 214B) can be employed to communicate, store, analyze, and/or otherwise process data related to financial transactions occurring between and/or among the third party 202, the corporation 204, the depositary 206, the employee 207 and/or the investor 208.

In one implementation, one or more elements of the system 200 may function as an issuing agent (e.g. underwriter) for issuing a convertible security to a holder and/or a remarketing agent for offering, on one or more remarketing dates. In one embodiment, the system 200 may be configured to store and modify the securities. For example, data entries within the system may expire or convert at a certain time for remarketing.

The benefits of the present methods, systems and computer-readable media are readily apparent to those skilled in the art. The term “computer-readable medium” as used herein may include, for example, magnetic and optical memory devices such as diskettes, compact discs of both read-only and writeable varieties, optical disk drives, and hard disk drives. A computer-readable medium may also include memory storage that can be physical, virtual, permanent, temporary, semi-permanent and/or semi-temporary. A computer-readable medium may further include one or more data signals transmitted on one or more carrier waves. The various portions and components of various embodiments of the present invention can be implemented in computer software code using, for example, Visual Basic, C, or C++ computer languages using, for example, object-oriented techniques.

While several embodiments of the invention have been described, it should be apparent, however, that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

1. A convertible security comprising:
a maturity component providing a maturity term of the convertible security;
a conversion component providing terms and conditions for converting the convertible security for another asset;
a contingent component providing one or more payment contingencies triggered upon the occurrence of one or more specified conditions; and
a remarketing component providing terms and conditions for remarketing the convertible security to new investors,
wherein, after remarketing, the convertible security remains outstanding and potential recapture of excess tax benefits is postponed until the convertible security ceases to be outstanding.

2. The convertible security of claim 1, wherein the contingent component is structured to ensure that the convertible security qualifies for treatment as a contingent payment debt instrument under the tax code.

3. The convertible component of claim 1, wherein the contingent component provides a testing period for evaluating whether a contingency is triggered.

4. The convertible security of claim 1, wherein a contingent payment amount is based on fixed values.

5. The convertible security of claim 3, wherein a contingent payment amount is a percentage of average market price of the convertible security for the testing period.

6. The convertible security of claim 1, wherein the contingent component includes a contingency providing that if the convertible security trades above a threshold multiple of the par or accreted value, a contingent payment is made.

7. The convertible security of claim 6, wherein the contingent payment is a percentage of average market price.

8. The convertible security of claim 1, wherein the contingent component includes a contingency providing that a coupon will be stepped up if the stock trades below a certain percentage of a conversion price.

9. The convertible security of claim 1, wherein projected contingent payments are calculated based on forward prices and expected values of the projected contingent payments.

10. The convertible security of claim 9, wherein a comparable yield is determined by referencing a yield of a fixed-rate nonconvertible debt instrument with terms and conditions similar to terms and conditions of the convertible security.

11. The convertible security of claim 9, wherein, a projected payment schedule includes each noncontingent payment and the projected contingent payments.

12. The convertible security of claim 9, wherein adjustments are made based on a comparison of projected contingent payments to actual contingent payments.

13. The convertible security of claim 1, wherein the remarketing component provides that the convertible security is remarketed as a new straight debt security.

14. The convertible security of claim 1, wherein the remarketing component provides that the convertible security is remarketed as a new convertible security.

15. The convertible security of claim 1, wherein a determination of whether to remarket is based on a comparison of a stock price and a conversion price at a remarketing time.

16. The convertible security of claim 15, wherein if the stock price at the remarketing time is greater than or equal to the conversion price, the convertible security is not remarketed.

17. The convertible security of claim 15, wherein if the stock price at the remarketing time date is less than the conversion price, the convertible security is remarketed as straight debt.

18. The convertible security of claim 15, wherein if the stock price at the remarketing time is less than the conversion price, the convertible security is remarketed as a new convertible security that may be remarketed again.

19. The convertible security of claim 15, wherein if the stock price at the remarketing time is less than the conversion price, the convertible security is remarketed as a new convertible security that may not be remarketed again.

20. The convertible security of claim 15, wherein the determination on whether or not the convertible security will be remarketed is made on multiple remarketing dates.

21. The convertible security of claim 1, wherein a determination of whether to remarket is based on a comparison of a bond price and a fixed price at a remarketing time.

22. The convertible security of claim 21, wherein if the bond price at the remarketing time is greater than or equal to a fixed price, the convertible security is not remarketed.

23. The convertible security of claim 21, wherein if the bond price at the remarketing time is less than a fixed price, the convertible security is remarketed as a straight debt security.

24. The convertible security of claim 21, wherein if the bond price at the remarketing time is less than the fixed price, the convertible security is remarketed as a new convertible security that may be remarketed again.

25. The convertible security of claim 21, wherein if the bond price at the remarketing time is less than the fixed price, the convertible security is remarketed as a new convertible security that may not be remarketed again.

26. The convertible security of claim 21, wherein the determination of whether to remarket is made on multiple remarketing dates.

27. The convertible security of claim 1, further comprising a warrant component.

28. The convertible security of claim 27, wherein the warrant component provides investors with an option for an additional number of shares above a conversion price.

29. The convertible security of claim 27, wherein the warrant component fixes a conversion rate.

30. The convertible security of claim 1, further comprising a call component providing a call protection period.

31. The convertible security of claim 1, wherein the convertible security comprises one or more remarketing dates.

32. The convertible security of claim 1, wherein after remarketing the security cannot be paid in stock and cannot be converted into stock of the issuer.

33. The convertible security of claim 1, wherein the term is thirty years.

34. The convertible security of claim 1, further comprising a coupon component providing a floating rate.

35. A financial method comprising the steps of:
issuing a convertible security to a holder, the convertible security including a maturity component providing a maturity term of the convertible security, a conversion component providing terms and conditions for exchanging the convertible security for another asset, a contingent component providing one or more payment contingencies triggered upon the occurrence of one or more specified conditions, and a remarketing component providing terms and conditions for remarketing the convertible security to new investors; and
offering, at a remarketing time, the convertible security to one or more new investors,
wherein, after remarketing, the convertible security remains outstanding and potential recapture of excess tax benefits is postponed until the convertible security ceases to be outstanding.

36. The method of claim 35, further comprising calculating projected contingent payments.

37. The method of claim 36 wherein the projected contingent payments are calculated based on the forward prices and expected value of the contingent payments.

38. The method of claim 37, wherein a comparable yield is determined by referencing a yield of a fixed-rate nonconvertible debt instrument with terms and conditions similar to terms and conditions of the convertible security.

39. The method of claim 37, wherein a projected payment schedule includes each noncontingent payment and the projected contingent payments.

40. The method of claim 36, further comprising making adjustments based on a comparison of projected contingent payments to actual contingent payments.

41. The method of claim 40, wherein if the actual contingent payments are greater than the projected contingent payments, a positive adjustment is made.

42. The method of claim 40, wherein if the actual contingent payments are less than the projected contingent payments, a negative adjustment is made.

43. The method of claim 35, wherein the convertible security is remarketed as a new straight debt security.

44. The method of claim 35, wherein the convertible security is remarketed as a new convertible security.

45. The method of claim 35, wherein a determination of whether to remarket is made based on a comparison of a stock price and a conversion price at a remarketing time.

46. The method of claim 35, wherein a determination of whether to remarket is made based on a comparison of a bond price and a fixed price at a remarketing time.

47. A computer system comprising:
an issuing agent for issuing a convertible security to a holder, the convertible security including a maturity component providing a maturity term of the convertible security, a conversion component providing terms and conditions for exchanging the convertible security for another asset, a contingent component providing one or more payment contingencies triggered upon the occurrence of one or more specified conditions, and a remarketing component providing terms and conditions for remarketing the convertible security to new investors; and
a remarketing agent for offering, at a remarketing time, the convertible security to one or more new investors, wherein, after remarketing, the convertible security remains outstanding and potential recapture of excess tax benefits is postponed until the convertible security ceases to be outstanding.
